(19) United States
(12) Patent Application Publication
(10) Pub. No.: US 2010/0102148 A1
(43) Pub. Date: Apr. 29, 2010

(54) ELECTROSTATIC ATOMIZER

(75) Inventors: Sumio Wada, Osaka (JP); Yutaka Uratani, Osaka (JP); Takaoki Matsumoto, Osaka (JP)

Correspondence Address: GREENBLUM & BERNSTEIN, P.L.C., 1950 ROLAND CLARKE PLACE, RESTON, VA, 20191, US

(73) Assignee: PANASONIC ELECTRIC WORKS CO., LTD., Osaka (JP)

(21) Appl. No.: 12/518,913

(22) PCT Filed: Dec. 12, 2007
(86) PCT No.: PCT/JP2007/074349

§ 371 Date: Jun. 12, 2009

(30) Foreign Application Priority Data
Dec. 15, 2006 (JP) 2006-338881

(51) Int. Cl. B05B 5/00

(52) U.S. Cl. 239/690

(57) ABSTRACT

Disclosed is an electrostatic atomizer, which is capable of stably producing nanometer-sized mist droplets while using low withstand voltage circuit components and simplifying a circuit configuration. The electrostatic atomizer of the present invention is designed to stabilize an output voltage of a high-voltage generator by an output stabilizer during an operation of applying a high-voltage generator to a discharge electrode supplied with a liquid to be electrostatically atomized, so as to induce a discharge to electrostatically atomize the liquid. The high-voltage generator includes a self-oscillation type DC/DC converter having a transformer and a switching element, and the output stabilizer is operable to adjust a time period of an ON state of the switching element, based on a voltage induced in the control winding during the ON state of the switching element.

### TECHNICAL FIELD

The present invention relates to an electrostatic atomizer for generating nanometer-sized mist droplets.

### BACKGROUND ART

There has been known an electrostatic atomizer designed to apply a high voltage between a discharge electrode and a counter electrode to induce a discharge therebetween, while supplying a liquid (e.g., water) onto the discharge electrode, so as to atomize the liquid held on the discharge electrode through Rayleigh breakup caused in the liquid to produce nanometer-sized charged fine water droplets (i.e., nanometer-sized mist droplets).

The charged fine water droplets characteristically contain radicals and have a relatively long duration of a mist state, so that they can be spread over a target space in large numbers to effectively act on malodorous substances attached, for example, on a wall surface, clothes and curtains in a room, and exert a deodorizing effect.

In one type of electrostatic atomizer where water stored in a water tank is supplied to a discharge electrode by means of a capillary phenomenon, a user will be obliged to perform an operation of refilling the water tank with water every time it becomes empty. As another type capable of eliminating the need for the refilling operation, there has been known an electrostatic atomizer equipped with a heat exchange section adapted to cool air so as to produce water, wherein water produced by the heat exchanger (i.e., condensation water) is supplied onto a charge electrode. In this type of electrostatic atomizer, it is necessary to assume a relatively long time of at least about several minutes before condensation water produced by the heat exchanger is sent to the discharge electrode.

The applicant of this application has proposed an electrostatic atomizer which comprises a cooler adapted to cool a discharge electrode so as to allow condensation water to be produced on a surface of a charge electrode based on moisture in air, and a controller adapted to detect a discharge current flowing between the discharge electrode and a counter electrode and control the cooler in such a manner as to maintain the discharge current at a predetermined value (see the following Patent Publication 1).

As one of the measures for allowing this type of electrostatic atomizer to stably generate mist droplets, there is a concept of stabilizing an output of a high-voltage output circuit. It is contemplated to realize the concept by directly detecting a high voltage to be applied between the discharge and counter electrodes, and adjusting the output of the high-voltage output circuit based on the detected voltage to allow the output of the high-voltage output circuit to become equal to a target value. However, this technique of directly detecting the output voltage of the high-voltage output circuit to adjustably stabilize the output voltage of the high-voltage output circuit is essentially required to make up a detection circuit using circuit components capable of withstanding the high voltage (i.e., high withstand voltage circuit components). This involves a problem about complexity in circuit configuration which leads to increases in cost and size of the electrostatic atomizer.

[Patent Publication 1] Japanese Unexamined Patent Publication No. 2006-122819

### DISCLOSURE OF THE INVENTION

In view of the above conventional problems, it is an object of the present invention to provide an electrostatic atomizer which can stably produce nanometer-sized mist droplets while simplifying a circuit configuration.

In order to achieve the above object, according to an aspect of the present invention, an electrostatic atomizer comprises a high-voltage generator adapted to apply a high voltage to a discharge electrode supplied with a liquid to be electrostatically atomized, so as to induce a discharge, and an output stabilizer adapted to stabilize an output voltage of the high-voltage generator. In the electrostatic atomizer, the high-voltage generator includes a self-oscillation type DC/DC converter provided with a transformer having a primary winding, a secondary winding and a control winding, and a switching element connected in series between opposite poles of a DC power supply via the primary winding and adapted to be applied with an induction voltage generated in the control winding, through a control terminal thereof. The self-oscillation type DC/DC converter is operable to output to the discharge electrode an induction voltage generated in the secondary winding according to a switching action of the switching element. The output stabilizer is operable to adjust a time period of an ON state of the switching element, based on a voltage induced in the control winding during the ON state of the switching element.

In the electrostatic atomizer, the output stabilizer is operable to adjust a time period of the ON state of the switching element, based on a voltage induced in the control winding during the ON state of the switching element, so as to stabilize an output voltage of the high-voltage generator. Thus, the output voltage of the high-voltage generator can be stabilized using relatively low withstand voltage circuit components, as compared with the aforementioned conventional technique of detecting the output voltage of the high-voltage generation circuit to adjustably stabilize the output voltage of the high-voltage generation circuit, and without the need for electrically insulating between primary and secondary sides (of the transformer) of the high-voltage generator. This makes it possible to stably produce nanometer-sized mist droplets while simplifying a circuit configuration.

### BRIEF DESCRIPTION OF DRAWINGS

FIG. 1 is a circuit diagram showing a specific circuit configuration of an electrostatic atomizer according to a first embodiment of the present invention.

FIG. 2 is a block diagram showing the electrostatic atomizer in FIG. 1.

FIG. 3 is a block diagram showing an electrostatic atomizer according to a second embodiment of the present invention.

FIG. 4 is a circuit diagram showing a specific circuit configuration of the electrostatic atomizer in FIG. 3.

### BEST MODE FOR CARRYING OUT THE INVENTION

With reference to the drawings, the present invention will now be specifically described based on embodiments thereof.

### First Embodiment

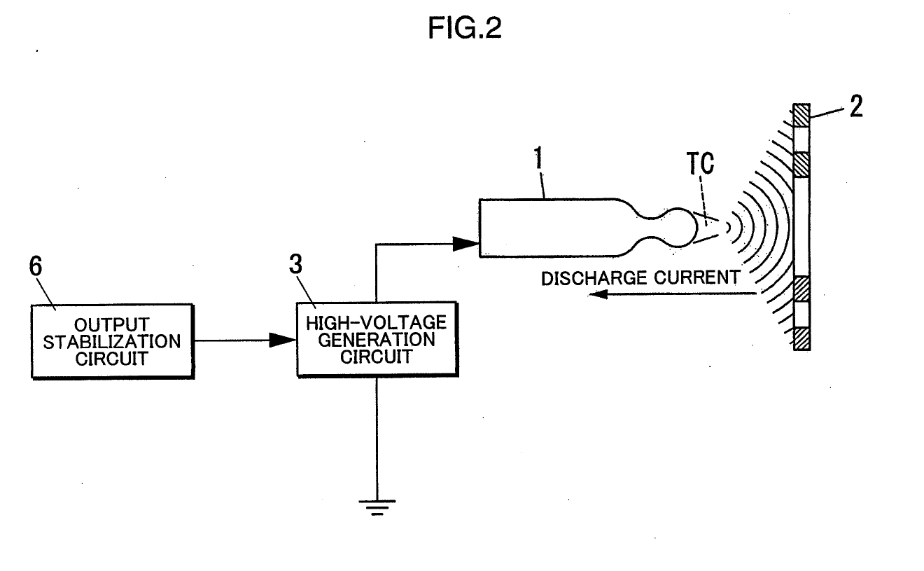

As shown in FIG. 2, an electrostatic atomizer according to a first embodiment of the present invention comprises a discharge electrode 1, a counter electrode 2 disposed in opposed relation to a distal end of the discharge electrode 1 with a given distance therebetween and formed to have a circular-shaped inner edge serving as a substantial electrode, a high-voltage generation circuit 3 adapted to apply a high voltage between the discharge and counter electrodes 1, 2 so as to a discharge therebetween, and an output stabilization circuit 6 adapted to stabilize an output voltage of the high-voltage generation circuit 3. In the first embodiment, the counter electrode 2 provided in the electrostatic atomizer is grounded. In a discharging operation, a high negative or positive voltage (e.g., several-kilovolt negative voltage) is applied to the discharge electrode 1. Simultaneously, a liquid (e.g., water) is supplied onto the discharge electrode 1 through conventional supplier (e.g., the water tank or the cooler as mentioned in the “Background Art”; not shown).

When a discharge voltage is applied between the discharge electrode 1 and the counter electrode 2 under a condition that water (e.g., condensation water) is attached on the discharge electrode 1, the water on the discharge electrode 1 is pulled toward the counter electrode 2 to have a shape, called “Taylor cone” TC, and formed as manometer-sized charged fine water droplets through Rayleigh breakup occurring at a tip end of the Taylor cone TC, so as to achieve atomization of the liquid (water). During this process, if the discharge voltage (i.e., an output voltage of the high-voltage generation circuit 3) fluctuates, an amount of charged fine water droplets to be produced will unstably increase and decrease. Thus, the stabilization in the output voltage of the high-voltage generation circuit 3 is essential for stabilizing an amount of charged fine water droplets to be generated. In order to meet this requirement, the electrostatic atomizer according to the first embodiment is provided with the output stabilization circuit 6 adapted to stabilize the output voltage of the high-voltage generation circuit 3.

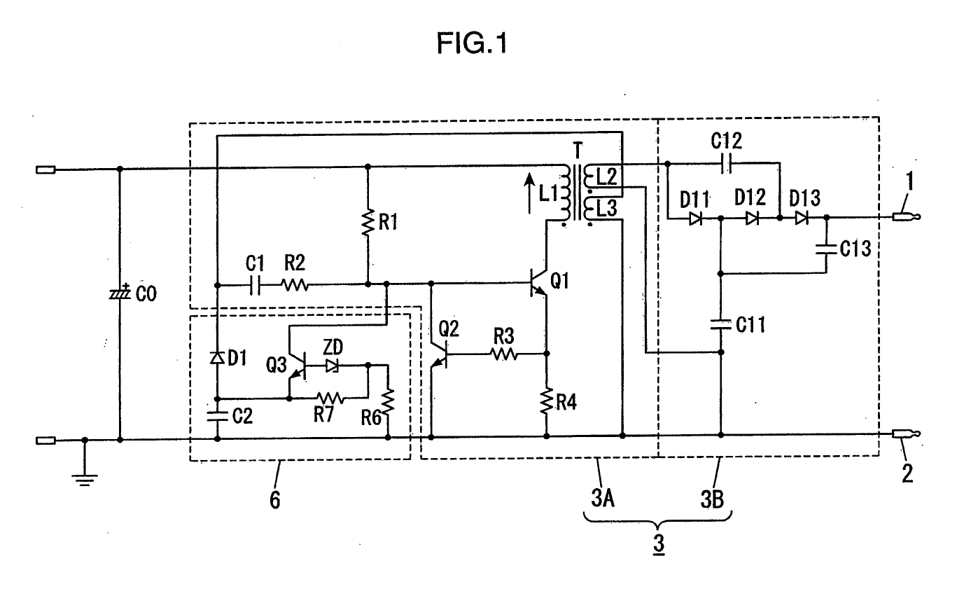

FIG. 1 is a circuit diagram showing a specific circuit configuration of the electrostatic atomizer according to the first embodiment.

The high-voltage generation circuit 3 comprises a conventional ringing choke converter 3A and a multistage (in the illustrated embodiment, 3-stage) voltage doubler rectifier circuit 3B. The ringing choke converter 3A includes: a transformer T which has a primary winding L1, a secondary winding L2 magnetically coupled to the primary winding L1, and a control winding L3; and a series circuit which is formed by the primary winding L1 of the transformer T, a switching element Q1 consisting of a NPN-type bipolar transistor, and a resistor R4, and connected to opposite poles of a DC power supply (smoothing capacitor C0). The voltage doubler rectifier circuit 3B is provided with three diodes D11, D12, D13 and three capacitors C11, C12, C13, and connected to the secondary winding L2 of the ringing choke converter 3A. In the ringing choke converter 3A, one terminal of the control winding 13 of the transformer T is connected to a control terminal (base) of the switching element Q1 through a series circuit formed by a capacitor C1 and a resistor R2. The ringing choke converter 3A further includes: a resistor R1 which is inserted between a positive terminal (i.e., positive pole) of the smoothing capacitor C0 and the base of the switching element Q1; and a switching element Q2 which consists of a NPN-type bipolar transistor, and has a base connected to an emitter of the switching element Q1 through a resistor R3, a collector connected to the base of the switching element Q1, and an emitter connected to a connection point connecting the resistor R4 and the control winding 13.

A fundamental operation of the high-voltage generation circuit 3 will be briefly described below. When a DC voltage is generated across the smoothing capacitor C0 serving as a DC power supply, a drive current is supplied to the base of the switching element Q1 through the resistor R1 to switch the switching element Q1 to its ON state so as to start supplying a current to the primary winding L1 of the transformer T through the switching element Q1 (in this state, the secondary winding L2 has a polarity opposite to that the primary winding L1, and thereby magnetic energy is accumulated in the primary winding L1). Then, when a voltage across the resistor R4 is increased up to a predetermined value along with an increase of the current, the switching element Q2 is switched to its ON state. Thus, the base of the switching element Q1 is connected to ground through the switching element Q2, and thereby the switching element Q1 is switched to its OFF state. In response to the switching of the switching element Q1 to the OFF state, the switching element Q2 is switched to its OFF state due interruption of the current to be supplied to the resistor R4, and a counter-electromotive force is generated in the primary winding L1 to allow the magnetic energy accumulated in the primary winding L1 to be released to the secondary winding L2 so as to induce a voltage in the secondary winding L2. The magnetic energy accumulated in the primary winding L1 is also released to the control winding L3 to induce a voltage in the control winding 13, so that a drive current is supplied to the base of the switching element Q1 to switch the switching element Q1 to the ON state. In this manner, a self-oscillation operation will be repeatedly performed. The voltage induced in the secondary winding L2 during the OFF state of the switching element Q1 is rectified and boosted by the voltage doubler rectifier circuit 3B, and then applied between the discharge electrode 1 and the counter electrode 2 as an output voltage of the high-voltage generation circuit 3. In the above operation, a voltage to be induced in the secondary winding L2 becomes higher as a timing of switching the switching element Q1 to the OFF state (i.e., a timing of switching the switching element Q2 to the ON state) is more largely delayed, and becomes lower as the timing of switching the switching element Q1 to the OFF state (i.e., the timing of switching the switching element Q2 to the ON state) is more largely advanced. That is, the output voltage of the high-voltage generation circuit 3 can be adjusted by controlling a switching timing (i.e., a time period of the ON state) of the switching element Q1.

The output stabilization circuit 6 will be specifically described below. The output stabilization circuit 6 comprises a diode D1 serving as a rectifying element, a smoothing capacitor C2, a transistor Q3 serving as a control switch element Q3, two voltage-dividing resistors R6, R7, and a zener diode ZD. The diode D1 has a cathode connected to a connection point connecting the control winding L3 and the capacitor C1, and the smoothing capacitor C2 is inserted between an anode of the diode D1 and the ground. The transistor Q3 consists of a NPN-type bipolar transistor, and has a collector connected to the base of the switching element Q1, an emitter connected to the anode of the diode D1 and a base connected to an anode of the zener diode ZD. The voltage-dividing resistor R6 is inserted between a cathode of the zener diode ZD and the ground, and the voltage-dividing resistor R7 is inserted between the cathode of the zener diode ZD and the emitter of the transistor Q3. Thus, when a voltage (serving as a referenced voltage) obtained by dividing a voltage across the smoothing capacitor C2 by the voltage-dividing resistors R6, R7 becomes greater than a composite voltage (serving as a threshold voltage) which is a sum of a zener voltage of the zener diode ZD and a base-emitter voltage of the transistor Q3, the transistor Q3 is switched to its ON state, and thereby a base voltage of the switching element Q1 is lowered to allow the switching element Q1 to be switched to the OFF state.

An operation of the output stabilization circuit 6 will be more specifically described below. When the switching element Q1 is switched to the OFF state during the self-oscillation operation of the ringing choke converter 3A, a counter-electromotive force is generated in the primary winding L1 in a direction indicated by the solid arrow in FIG. 1, as mentioned above, and thereby an induction voltage having the same polarity as that of the counter-electromotive force is generated in the control winding 13 to supply a drive current to the switching element Q1 through the capacitor C1 and the resistor R2 so as to switch the switching element Q1 to the ON state. During this process, the diode D1 is maintained in a non-conduction state to preclude a current from flowing through the output stabilization circuit 6. Thus, no reference voltage is generated.

Differently, when the switching element Q1 is in the ON state, the polarity of the induction voltage to be generated in the control winding L3 is reversed, and thereby the diode D1 is placed into a conduction state. Thus, the induction voltage of the control winding 13 is applied to a series circuit formed by the voltage-driving resistor R6, R7, through the smoothing capacitor C2, and formed as a referenced voltage, while being rectified by the diode D1. In this process, the referenced voltage is unexceptionally formed as a negative voltage, because a ground-side electrode of the smoothing capacitor C2 has a higher potential. This referenced voltage is proportional to an induction voltage to be generated in the secondary winding L2. Specifically, the reference voltage is increased in response to a rising of an induction voltage to be generated in the secondary winding L2 (i.e., a rising of an output voltage to be generated in the high-voltage generation circuit 3), and lowered in response to a falling of the induction voltage to be generated in the secondary winding L2 (i.e., a falling of the output voltage to be generated in the high-voltage generation circuit 3). That is, when the output voltage to be generated in the high-voltage generation circuit 3 rises, an increasing rate of the referenced voltage becomes higher to advance a timing of switching the switching element Q3 to its ON state. Thus, the time period of the ON state of the switching element Q1 is reduced to allow for falling of the output voltage to be generated in the high-voltage generation circuit 3. Conversely, when the output voltage to be generated in the high-voltage generation circuit 3 falls, the increasing rate of the referenced voltage becomes lower to delay the timing of switching the switching element Q3 to the ON state. Thus, the time period of the ON state of the switching element Q1 is increased to allow for rising of the output voltage to be generated in the high-voltage generation circuit 3. In this manner, the output voltage of the high-voltage generation circuit 3 can be adjustably stabilized based on the above feedback control of the output stabilization circuit 6.

In the conventional electrostatic atomizer devoid of the output stabilization circuit 6, a time period of the ON state of the switching element Q1 has been adjusted by the switching element Q2. In this case, a timing of switching the switching element Q2 is dependent on a base voltage of the switching element Q2, and thereby largely fluctuated due to temperature changes, which leads to fluctuation in the output voltage of the high-voltage generation circuit 3 due to temperature changes. Moreover, it is difficult to adequately response to a load fluctuation, because the time period of the ON state of the switching element Q1 is adjusted based on an emitter current of the switching element Q1 (a current flowing through the primary winding L1 of the transformer T).

In contrast, the electrostatic atomizer according to the first embodiment is provided with the output stabilization circuit 6 is operable to adjust the time period of the ON state of the switching element Q1, based on the referenced voltage induced in the control winding L3 during the ON state of the switching element Q1, so as to stabilize the output voltage of the high-voltage generation circuit 3. Thus, the output voltage of the high-voltage generation circuit 3 can be stabilized using relatively low withstand voltage circuit components, as compared with the conventional technique of detecting the output voltage of the high-voltage generation circuit 3, and without the need for electrically insulating between primary and secondary sides (of the transformer T) of the high-voltage generation circuit 3. This makes it possible to stably produce nanometer-sized mist droplets while simplifying a circuit configuration. In addition, the referenced voltage has a polarity opposite to that of an induction voltage to be generated in the control winding L3 during the OFF state of the switching element Q1. Thus, as compared with a referenced voltage having the same polarity as that of the induction voltage to be generated in the control winding L3 during the OFF state of the switching element Q1 (i.e., having a positive polarity), an adjustable range of a control voltage (base voltage) to be applied to the control terminal (base) of the switching element Q1 can be extended. This provides an advantage of being able to adjust the time period of the ON state of the switching element Q1 readily and stably. Furthermore, the output stabilization circuit 6 can be made up of a transistor, a resistor, a diode and a capacitor, so as to facilitate simplification in circuit configuration as compared with a circuit configuration using a microcomputer and/or an A/D converter.

### Second Embodiment

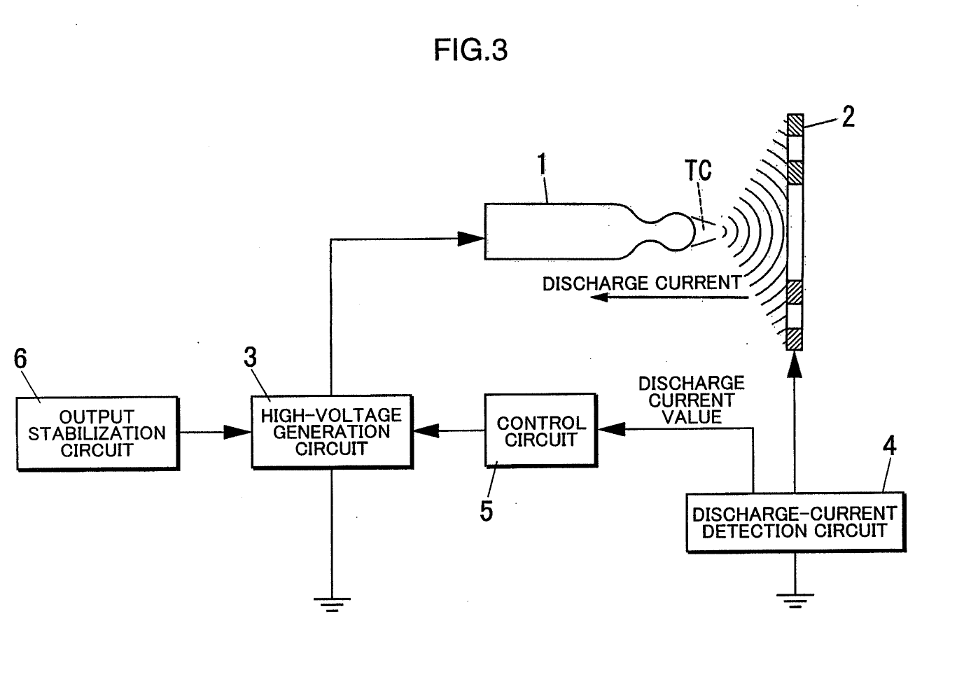

As shown in FIG. 3, an electrostatic atomizer according to a second embodiment of the present invention comprises a discharge electrode 1, a counter electrode 2, a high-voltage generation circuit 3 and an output stabilization circuit 6, as with the electrostatic atomizer according to the first embodiment. A feature of the electrostatic atomizer according to the second embodiment is in that it further includes a discharge-current detection circuit 4 adapted to detect a discharge current flowing between the discharge and counter electrodes 1, 2, through the counter electrode 2, and a control circuit 5 adapted to control an output of the high-voltage generation circuit 3 based on a detection result of the discharge-current detection circuit 4, in such a manner as to maintain a desired discharge state, wherein an operating power for the control circuit 5 is obtained from a referenced voltage.

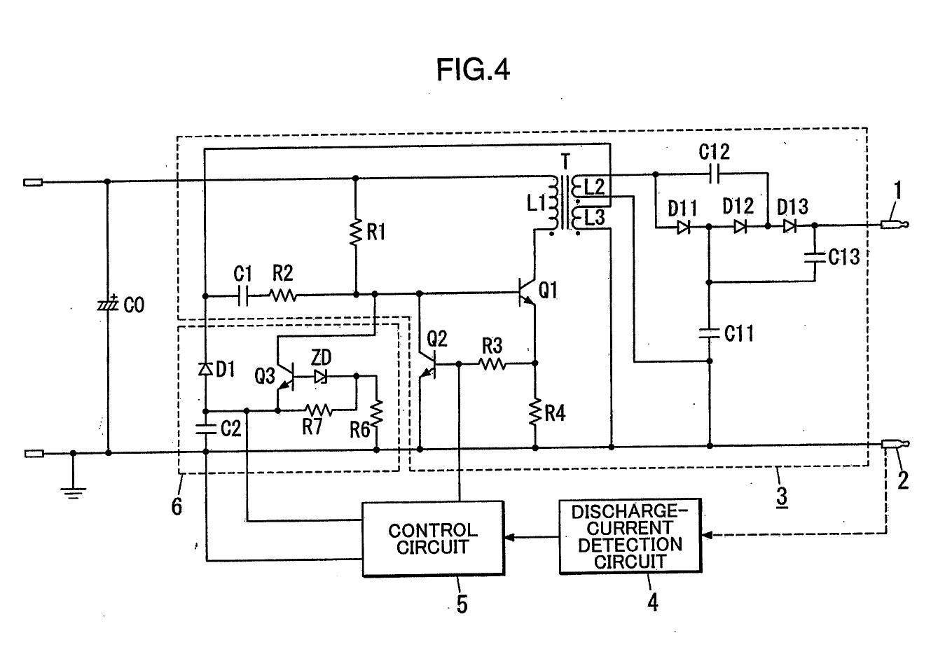

FIG. 4 is a circuit diagram showing a specific circuit configuration of the electrostatic atomizer according to the second embodiment. In FIG. 4, the high-voltage generation circuit 3 and the output stabilization circuit 6 are common to the first and second embodiments. Thus, each common element or component therein is defined by the same reference code, and its description will be omitted. The control circuit 5 is operable to perform a feedback control of comparing a detection voltage output from the discharge-current detection circuit 4 (i.e., a DC voltage proportional to a discharge current) with a predetermined reference voltage, and adjusting a discharge current in such a manner that, when the detection voltage becomes greater than the reference value, a switching element Q2 is switched to its ON state to reduce a time period of an ON state of the switching element Q1 so as to reduce the discharge current, and, when the detection voltage becomes equal to or less than the reference value, the switching element Q2 is switched to its OFF state to increase the time period of the ON state of the switching element Q1 so as to increase the discharge current. A smoothing capacitor C2 of the output stabilization circuit 6 is connected to the control circuit 5, so that an induction current generated in a control current L3 of a transformer T is rectified by a diode D1 to allow a direct current (referenced voltage) to be supplied to the control circuit 5 through the smoothing capacitor C2 and used as an operating power.

In the second embodiment, the operating power for the control circuit 5 is obtained from the referenced voltage. This makes it possible to eliminate the need for providing a power supply circuit for the control circuit 5 separately, so as to facilitate reduction in cost.

As described above, an inventive electrostatic atomizer comprises a discharge electrode supplied with a liquid to be electrostatically atomized, a counter electrode disposed in opposed relation to the discharge electrode, a high-voltage generator adapted to apply a high voltage between the discharge electrode and the counter electrode, and an output stabilizer adapted to stabilize an output voltage of the high-voltage generator. In the electrostatic atomizer, the high-voltage generator includes a self-oscillation type DC/DC converter provided with a transformer having a primary winding, a secondary winding and a control winding, and a switching element connected in series between opposite poles of a DC power supply via the primary winding and adapted to be applied with an induction voltage generated in the control winding, through a control terminal thereof. The self-oscillation type DC/DC converter is operable to output to the discharge electrode an induction voltage generated in the secondary winding according to a switching action of the switching element. The output stabilizer is operable to adjust a time period of an ON state of the switching element, based on a voltage induced in the control winding during the ON state of the switching element.

In the electrostatic atomizer, the output stabilizer is operable to adjust a time period of the ON state of the switching element, based on a referenced voltage induced in the control winding during the ON state of the switching element. Thus, the output voltage of the high-voltage generator can be stabilized using relatively low withstand voltage circuit components, as compared with the conventional technique of detecting the output voltage of the high-voltage generation circuit to adjustably stabilize the output voltage of the high-voltage generation circuit, and without the need for electrically insulating between primary and secondary sides (of the transformer) of the high-voltage generator. This makes it possible to stably produce nanometer-sized mist droplets while simplifying a circuit configuration.

Preferably, in the electrostatic atomizer, the output stabilizer is operable to compare the referenced voltage induced in the control winding, with a predetermined threshold voltage, and, in response to a change in a magnitude relationship between the referenced voltage and the threshold voltage, switch the switching element to its OFF state. According to this feature, the output stabilizer can be achieved in a simplified circuit configuration without using a microcomputer or the like.

Preferably, the referenced voltage has a polarity opposite to that of a voltage to be induced in the control winding during the OFF state of the switching element. According to this feature, the polarity of the referenced voltage can be set to be opposite to that of a voltage to be induced in the control winding during the OFF state of the switching element. Thus, in a control of the switching action of the switching element, an adjustable range of a voltage (control voltage) to be applied to the control terminal of the switching element can be extended, as compared with a referenced voltage having the same polarity as that of an induction voltage to be generated in the control winding during the OFF state of the switching element. This makes it possible to adjust the time period of the ON state of the switching element readily and stably. Furthermore, the output stabilization circuit 6 can be made up of a transistor, a resistor, a diode and a capacitor, so as to facilitate simplification in circuit configuration as compared with a circuit configuration using a microcomputer and/or an A/D converter.

Preferably, the output stabilizer includes a series circuit formed by a rectifying element and a smoothing capacitor and connected between opposite terminals of the control winding, and a control switch element adapted to be switched to its ON state when a voltage across the smoothing capacitor becomes greater than a predetermined threshold voltage, wherein the control terminal of the switching element, and one terminal of the series circuit formed by the rectifying element and the smoothing capacitor, are connected to one of the terminals of the control winding, and the control switch element is inserted between the control terminal of the switching element and a connection point connecting the rectifying element and the smoothing capacitor. According to this feature, the time period of the ON state of the switching element can be adjusted readily and stably in a simplified configuration.

Preferably, any circuit in the electrostatic atomizer, except for the output stabilizer, is adapted to obtain an operating voltage thereof from the referenced voltage. According to this feature, an operating voltage of any circuit in the electrostatic atomizer, except for the output stabilizer, can be obtained from the referenced voltage to minimize a power supply circuit so as to facilitate reduction in cost.

In this specification, an element or component described in the form of means for achieving a certain function is not limited to a specific structure, configuration or arrangement disclosed in the specification to achieve such a function, but may include any other suitable structure, configuration or arrangement, such as a unit, a mechanism or a component, capable of achieving such a function.

### INDUSTRIAL APPLICABILITY

According to an aspect of the present invention, an electrostatic atomizer is designed to stabilize an output voltage of a high-voltage generator by an output stabilizer during an operation of applying a high voltage from the high-voltage generator to a discharge electrode supplied with a liquid to be electrostatically atomized, so as to induce a discharge to electrostatically atomize the liquid. The high-voltage generator includes a self-oscillation type DC/DC converter having a transformer and a switching element, and the output stabilizer is operable to adjust a time period of an ON state of the switching element, based on a voltage induced in the control winding during the ON state of the switching element. This electrostatic atomizer can stably produce nanometer-sized mist droplets while simplifying a circuit configuration.

1. An electrostatic atomizer comprising a high-voltage generator adapted to apply a high voltage to a discharge electrode supplied with a liquid to be electrostatically atomized, so as to induce a discharge, and an output stabilizer adapted to stabilize an output voltage of said high-voltage generator, wherein:
said high-voltage generator includes a self-oscillation type DC/DC converter provided with a transformer having a primary winding, a secondary winding and a control winding, and a switching element connected in series between opposite poles of a DC power supply via said primary winding and adapted to be applied with an induction voltage generated in said control winding, through a control terminal thereof, said self-oscillation type DC/DC converter being operable to output to said discharge electrode an induction voltage generated in said secondary winding according to a switching action of said switching element; and
said output stabilizer is operable to adjust a time period of an ON state of said switching element, based on a voltage induced in said control winding during the ON state of said switching element.

2. The electrostatic atomizer as defined in claim 1, wherein said output stabilizer is operable to compare a referenced voltage induced in said control winding, with a predetermined threshold voltage, and, in response to a change in a magnitude relationship between said referenced voltage and said threshold voltage, switch said switching element to its OFF state.

3. The electrostatic atomizer as defined in claim 2, wherein said referenced voltage has a polarity opposite to that of a voltage to be induced in said control winding during the OFF state of said switching element.

4. The electrostatic atomizer as defined in claim 3, wherein said output stabilizer includes a series circuit formed by a rectifying element and a smoothing capacitor and connected between opposite terminals of said control winding, and a control switch element adapted to be switched to its ON state when a voltage across said smoothing capacitor becomes greater than a predetermined threshold voltage, wherein:
said control terminal of said switching element, and one terminal of said series circuit formed by said rectifying element and said smoothing capacitor, are connected to one of said terminals of said control winding; and
said control switch element is inserted between said control terminal of said switching element and a connection point connecting said rectifying element and said smoothing capacitor.

5. The electrostatic atomizer as defined in claim 1, wherein any circuit, except for said output stabilizer, is adapted to obtain an operating voltage thereof from said referenced voltage.
